(19) United States
(12) Patent Application Publication
(10) Pub. No.: US 2014/0298786 A1
(43) Pub. Date: Oct. 9, 2014

(54) TORQUE CONVERTER BEARING CENTERING PLATE

(71) Applicants: SCHAEFFLER GROUP USA, INC., Fort Mill, SC (US); SCHAEFFLER TECHNOLOGIES GMBH & CO. KG, Herzogenaurach (DE)

(72) Inventor: Patrick Lindemann, Wooster, OH (US)

(73) Assignees: SCHAEFFLER GROUP USA, INC., Fort Mill, SC (US); SCHAEFFLER TECHNOLOGIES GMBH & CO. KG, Herzogenaurach (DE)

(21) Appl. No.: 14/242,071

(22) Filed: Apr. 1, 2014

Related U.S. Application Data
(60) Provisional application No. 61/807,898, filed on Apr. 3, 2013.

(51) Int. Cl. F16H 41/04; F16H 41/24; F16H 41/28

(52) U.S. Cl. CPC F16H 41/04; F16H 41/28; F16H 41/24
USPC 60/364; 29/889

(57) ABSTRACT

A torque converter having a housing with an impeller wall section, and pump vanes brazed to the impeller wall section. The housing is connected to an output of an engine for rotation about a longitudinal axis. A turbine having turbine vanes that are connected to a hub is located about the longitudinal axis within the housing and is connected to an input shaft of a transmission. A stator is located between the pump vanes and the turbine vanes. In order to allow for a thinner housing wall, particularly an area of the impeller wall section, an annular retainer plate is brazed to the impeller wall section about the longitudinal axis and forms a reinforcement. A rolling bearing is located between the retainer plate and the stator, and is used in supporting the housing. An assembly method is also provided.

### INCORPORATION BY REFERENCE

The following documents are incorporated herein by reference as if fully set forth: U.S. Provisional Application No.: 61/807,898, filed Apr. 3, 2013.

### FIELD OF INVENTION

The present invention relates to torque converters, and in particular to a torque converter pump assembly.

### BACKGROUND

Hydraulic torque converters used in connection with internal combustion engines in order to transfer torque from the engine to the transmission are known in the art. One known torque converter is shown in U.S. Pat. No. 6,742,638, a portion of which is shown in FIG. 1 in the present application as prior art. This torque converter includes a flex plate 2 which is used for connection to the flywheel of an internal combustion engine in order to provide input power from the engine to the torque converter. This flex plate 2 is connected to a housing 3 of the torque converter in which a hydraulic coupling takes place between the power input from the engine and the input shaft 8 of the transmission. The housing 3 is typically constructed of sheet metal and includes a first wall section 3a and a second wall section 3b which are brazed or welded together. The second wall section 3b is typically preassembled with pump vanes to form the pump 4 by being brazed together with the pump vanes. Within the housing 3 is also a turbine 5 having turbine vanes which become hydraulically coupled to the pump vanes in order to rotate the transmission input shaft 8 by connection to a first hub 6 that is rotationally coupled via resilient energy storing elements 13 to a second hub 7, which preferably includes internal splines which are engaged by the input shaft 8. A stator 9 is provided between the vanes of the pump 4 and the turbine 5, and is located on a freewheel 9a supported on the stator shaft 1a. An auxiliary shaft 12 extends from the second housing part 3b about the longitudinal axis concentrically about the transmission input shaft 8 and the stator shaft 1a. As can be seen in FIG. 1, rolling bearings are located between the second housing section 3b and the stator 9 as well as between the stator 9 and the first hub 6. Friction linings 23 are provided on a piston 24 which engage adjacent friction surfaces 25, 26 located within the chamber 30.

Also known in the prior art from U.S. 2009/0155078 is a more efficient method of bonding pump blades to a pump housing section of a torque converter by initially assembling the blades and the hub and then brazing them together into an assembly.

U.S. Pat. No. 6,817,834 also discloses a torque converter with blades which are brazed to the housing, in which an annular retainer plate is also connected to the housing by brazing in order to retain the radially inner ends of the blades in position.

The drawbacks associated with many of these known arrangements include complex assembly as well as higher costs. Additionally, given the current drive toward efficiency, it would be desirable to provide for reduced weight as well as simplifying assembly of the torque converter.

### SUMMARY

A torque converter is provided having a housing with an impeller wall section, and pump vanes fixed to the impeller wall section. The housing is adapted to be connected to an output of an internal combustion engine for rotation about a longitudinal axis. A turbine having turbine vanes that are connected to a hub is located about the longitudinal axis within the housing and is adapted for connection to an input shaft of a transmission. A stator is located on a stator shaft that extends about the longitudinal axis, the stator being located between the pump vanes and the turbine vanes. In order to allow for a thinner housing wall, particularly in an area of the impeller wall section, an annular retainer plate is fixed to the impeller wall section about the longitudinal axis and forms a reinforcement. A rolling bearing is located between the retainer plate and the stator, and is used in supporting the housing.

By using the annular retainer plate as the reinforcement, a weight savings in the torque converter assembly can be achieved, without additional manufacturing steps, since the annular retainer plate can be brazed or welded in position at the same time or during the same operation as when the pump vanes are connected to the impeller wall section of the housing.

In one preferred aspect, the retainer plate includes an axial flange for centering the rolling bearing.

In a further aspect, the rolling bearing is a roller bearing located between the housing and the stator. The roller bearing preferably includes a locating feature on one race that engages an axial flange located on an outer periphery of the annular retainer plate for centering the roller bearing.

In another preferred aspect, the retainer plate is fixed to the housing wall section by brazing, welding, or an adhesive.

In another aspect, a method of assembling a torque converter is provided. A torque converter housing having an impeller wall section is provided. The impeller blades for a pump impeller and an annular retainer plate are positioned on the impeller wall section. The blades and the annular retainer plate are then fixed on the housing.

The annular retainer plate preferably includes an axial flange located on an outer periphery thereof for centering a rolling bearing.

Further, preferably after brazing or welding the annular retainer plate is machined to a final size for centering the bearing.

In one preferred method, the blades and the annular retainer plate are attached by furnace brazing, welding, or an adhesive.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is a partial cross-sectional view of a prior art torque converter.

FIG. 2 is an enlarged partial cross-sectional view through a torque converter according to the present invention.

FIG. 3 is a partial elevational view of an alternate embodiment of the retainer plate which includes grooves to promote the flow of transmission fluid between the bearing and the housing.

FIG. 4 is a cross-sectional view taken along lines 4-4 in FIG. 3.

FIGS. 5A-5C are a series of views showing the process or assembling and machining a retainer plate similar to that shown in FIG. 2.

FIGS. 6A-6C are a series of views similar to FIGS. 5A-5C showing the process or assembling and machining an alternate embodiment of a retainer plate.

FIGS. 7A-7C are a series of views similar to FIGS. 5A-5C showing the process or assembling and machining an alternate embodiment of a retainer plate.

### DETAILED DESCRIPTION OF THE PREFERRED EMBODIMENTS

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

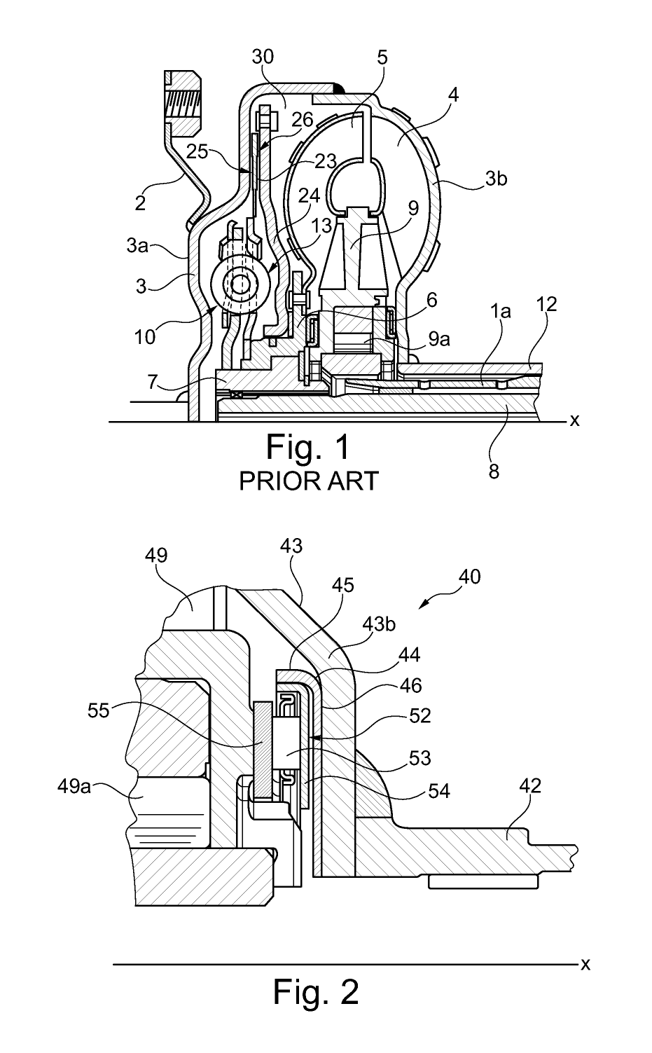

In FIG. 1, the prior art torque converter is shown. This arrangement requires a heavy wall for the pump housing at 3b in order to provide sufficient structure at the roller bearing located between the housing 3b and that stator 9.

Referring to FIG. 2 which is an enlarged partial cross-sectional view of a torque converter 40 according to the invention, which is similar to the prior art shown in FIG. 1, and shows the pump hub 42 which is welded or brazed to the housing 43 about the longitudinal axis X, as well as the partial wall section 43b of the housing to which the pump vanes are connected, also preferably by brazing or welding. In accordance with the present invention, an annular retainer plate 44 is connected, preferably by brazing 46 or welding, to the housing wall section 43b of the housing 43 about the longitudinal axis X. The retainer plate 44 preferably includes an axial flange 45 located at the outer peripheral edge thereof. The stator 49 is also shown located on a freewheel 49a that is located on the stator shaft (not shown in FIG. 2). A rolling bearing 52 is located between the annular retainer plate 44 and the stator 49. The bearing 52 is preferably a roller bearing and includes rollers 53 along with a first race 54 which preferably includes a location feature, such as an axially extending radially outer flange which can engage within the flange 45 of the annular retainer plate 44. The second axial race 55 of the roller bearing 52 is located against the stator 49.

Preferably, the retainer plate 44 can be machined after it is assembled to the pump vane section of the housing 43b to achieve final tolerances and fit for the bearing 52. This allows for easier centering of the roller bearing 52 during assembly.

According to the invention, the use of the retainer plate 44 allows for the housing wall section 43b with the pump vanes to be made of thinner material, thus saving weight since the annular retainer plate 44 provides an additional reinforcement in the area of the bearing 52. Further, according to the invention no additional assembly steps are required since the annular retainer plate 44 can be positioned along with the impeller blades for the pump impeller on the housing wall section 43b of the torque converter housing 43 and then the blades and the annular retainer plate 44 can be fixed to the housing 43, preferably by brazing, welding, or an adhesive, in a single operation, similar to the prior art which also required welding or brazing of the impeller blades for the pump impeller to the housing wall section. In a preferred embodiment, the blades and the annular retainer plate 44 are attached to the housing wall section 43b of the pump housing by furnace brazing in the same operation as brazing of the impeller blades for the pump to the housing wall section 43b of the torque converter housing 43. After brazing or welding the annular retainer plate 44 is machined to a final size for centering the bearing 52.

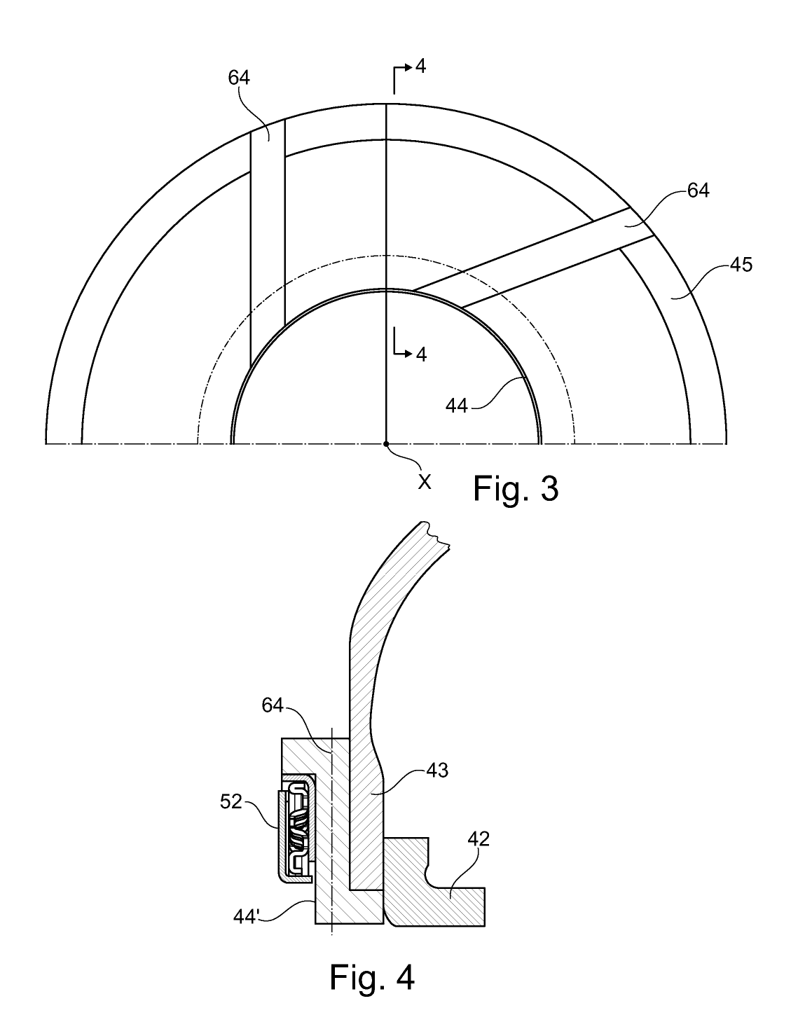

Referring to FIGS. 3 and 4, an alternate embodiment of the retainer plate 44′ is shown separately in a partial elevational view in FIG. 3 and in a partial section assembled in a torque converter 40 in FIG. 4. In this embodiment of the retainer plate 44′, grooves 64 that extend at least partly in a radial direction are machined in the retainer plate 44′ in order to promote the flow of transmission fluid between the bearing 52 and the housing 43. This provides for improved flow of the transmission fluid in the torque converter as well as through the bearing 52.

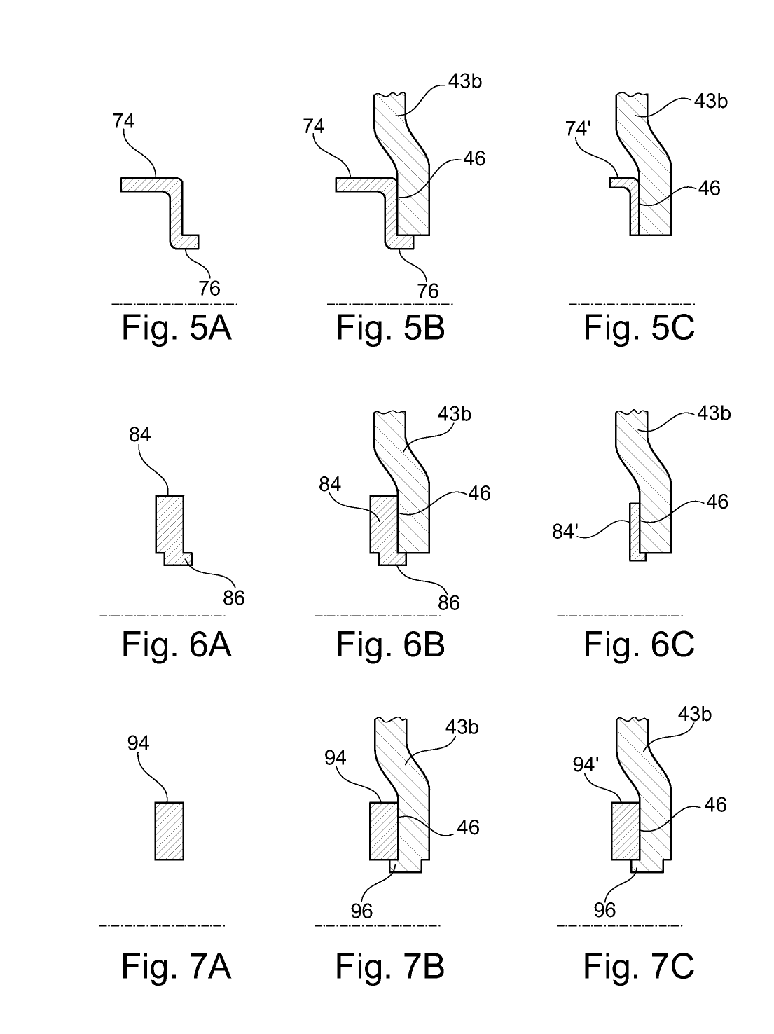

FIGS. 5A-5C show a series of process steps for connection of a retainer plate 74, having a similar cross-section to the retainer plates 44, 44′ above. The cross-section through the retainer plate 74 is shown in FIG. 5A, and the retainer plate 74 is preferably a stamped sheet metal part. An optional locating flange 76 that extends in the axial direction is provided on the inner periphery of the retainer plate 74 that can engage an inner radial edge of the housing part 43b. In FIG. 5B, the retainer plate 74 is shown brazed to the housing part 43b with brazing 46. In FIG. 5C, the retainer plate 74′ is shown after being machined along with the radial inner end of the housing wall section 43b.

FIGS. 6A-6C shown the same series of views of FIGS. 5A-5C for an alternate embodiment of the retainer plate 84, which can be a stamped or coined part. The retainer plate 84 also includes the optional locating flange 86 that extends in the axial direction from its inner peripheral edge. The machined retainer plate 84′ is shown in FIG. 6C.

FIGS. 7A-7C show a further alternate embodiment of the retainer plate 94 which is a stamped part. Here, the radially inner part of the housing wall section 43b includes a locating flange 96 for the retainer plate 94. Machining can still take place on the exposed axial face which contacts the bearing 52, resulting in the final configuration of the retainer plate 94′ in FIG. 7C.

According to the invention, a weight savings in the torque converter housing 43 is achieved by the use of the retainer plate 44 as a reinforcement while at the same time an additional centering feature of the bearing 52 is provided to assist in assembly of the torque converter.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A torque converter, comprising:
a housing having an impeller wall section and pump vanes brazed to the impeller wall section, the housing being adapted to be connected to an output of an internal combustion engine for rotation about a longitudinal axis;
a turbine having turbine vanes that are connected to a hub is located about the longitudinal axis in the housing and is adapted for connection to an input shaft of a transmission;
a stator located between the pump vanes and the turbine vanes;
an annular retainer plate fixed to the impeller wall section about the longitudinal axis that forms a reinforcement; and
a rolling bearing located between the retainer plate and the stator.

2. The torque converter of claim 1, wherein the retainer plate includes an axial flange for centering the rolling bearing.

3. The torque converter of claim 1, wherein the rolling bearing includes a locating feature on one race that engages an axial flange located on an outer periphery of the annular retainer plate for centering the rolling bearing.

4. The torque converter of claim 1, wherein the annular retainer plate is fixed to the impeller wall section by brazing, a weld, or an adhesive.

5. The torque converter of claim 1, wherein at least one of the impeller wall section of the housing or the retainer plate includes a locating element that engages with the other of the impeller wall section of the housing or the retainer plate.

6. A method of assembling a torque converter, comprising:
providing a torque converter housing having an impeller wall section;
positioning impeller blades for a pump impeller and an annular retainer plate on the impeller wall section; and
fixing the blades and the annular retainer plate on the housing.

7. The method of claim 6, wherein the annular retainer plate includes an axial flange located on an outer periphery thereof for centering a rolling bearing.

8. The method of claim 7, wherein after fixing the annular retainer plate is machined to a final size for centering the bearing.

9. The method of claim 6, wherein the blades and the annular retainer plate are attached by furnace brazing, welding, or an adhesive.

10. The method of claim 6, wherein at least one of the impeller wall section of the housing or the annular retainer plate includes a locating element that engages with the other of the impeller wall section of the housing or the retainer plate, and the positioning of the annular retainer plate on the impeller wall section includes aligning the locating element on the at least one of the impeller wall section of the housing or the annular retainer plate with the other of the impeller wall section of the housing or the retainer plate prior to fixing the annular retainer plate on the housing.
